(19) United States
(12) Patent Application Publication
(10) Pub. No.: US 2026/0043669 A1
(43) Pub. Date: Feb. 12, 2026

(54) SYSTEM AND INFORMATION GENERATION METHOD

(71) Applicant: TOYOTA JIDOSHA KABUSHIKI KAISHA, Toyota-shi (JP)

(72) Inventor: Yu NAGATA, Chofu-shi (JP)

(73) Assignee: TOYOTA JIDOSHA KABUSHIKI KAISHA, Toyota-shi (JP)

(21) Appl. No.: 19/281,149

(22) Filed: Jul. 25, 2025

(30) Foreign Application Priority Data
Aug. 6, 2024 (JP) 2024-129991

(51) Int. Cl. G01C 21/36; G06V 10/94; G06V 20/56

(52) U.S. Cl. CPC G01C 21/3679; G01C 21/3623; G01C 21/3655; G06V 10/95; G06V 20/56

(57) ABSTRACT

The information processing apparatus according to one aspect of the present disclosure acquires target image data from a driving recorder of a target vehicle using a charging facility at a target road rest facility, the target image data captured during an interval from when the target vehicle starts entering the target road rest facility to when the target vehicle arrives at the charging facility, performs image analysis on the acquired target image data, generates a guidance text to the charging facility at the target road rest facility according to a result of the image analysis, and stores the generated guidance text for providing to a user who uses the target road rest facility.

### CROSS REFERENCE TO THE RELATED APPLICATION

This application claims the benefit of Japanese Patent Application No. 2024-129991, filed on Aug. 6, 2024, which is hereby incorporated by reference herein in its entirety.

### BACKGROUND

### Technical Field

The present disclosure relates to a system and information generation method.

### Description of the Related Art

Japanese Patent Laid-Open No.2014-153339 proposes an in-vehicle device that provides facility information including a charger installation location when entering the parking area of a facility via an introduction road branching off from the main road.

### SUMMARY

One of the objects of the present disclosure is to provide a technique for reducing the cost of generating guidance information to the charging facility.

The information processing apparatus according to the first aspect of the present disclosure comprises a controller. The control unit is configured to execute acquiring target image data from a driving recorder of a target vehicle using a charging facility at a target road rest facility, the target image data captured during an interval from when the target vehicle starts entering the target road rest facility to when the target vehicle arrives at the charging facility, performing image analysis on the acquired target image data, generating a guidance text to the charging facility at the target road rest facility according to a result of the image analysis, and storing the generated guidance text for providing to a user who uses the target road rest facility.

The information generation method (information processing method) according to the second aspect of the present disclosure is executed by a computer. The information generation method comprises acquiring target image data from a driving recorder of a target vehicle using a charging facility at a target road rest facility, the target image data captured during an interval from when the target vehicle starts entering the target road rest facility to when the target vehicle arrives at the charging facility, performing image analysis on the acquired target image data, generating a guidance text to the charging facility at the target road rest facility according to a result of the image analysis, and storing the generated guidance text for providing to a user who uses the target road rest facility.

The system according to the third aspect of the present disclosure includes a server device and an in-vehicle device deployed in a target vehicle. The in-vehicle device is configured to execute, when the target vehicle is charged at a charging facility at a target road rest facility, extracting a target image data from an image data stored in a driving recorder of the target vehicle, the target image data captured during an interval from when the target vehicle starts entering the target road rest facility to when the target vehicle arrives at the charging facility, and transmitting the extracted target image data to the server device. The server device is configured to execute receiving the target image data from the in-vehicle device, performing image analysis on the received target image data, generating a guidance text to the charging facility at the target road rest facility according to a result of the image analysis, and storing the generated guidance text for providing to a user who uses the target road rest facility.

According to the present disclosure, the cost of generating guidance information to the charging facility can be reduced.

### BRIEF DESCRIPTION OF THE DRAWINGS

FIG. 1 schematically indicates an example of a situation in which the present disclosure is applied;

FIG. 2 schematically indicates an example of a road rest facility;

FIG. 3 schematically indicates an example of the time lapse from the vicinity of the entrance to arrival at the charging facility and the extracted interval;

FIG. 4 indicates an example of a processing procedure for generating a guidance text based on a rule;

FIG. 5A schematically indicates an example of the hardware configuration of a server device;

FIG. 5B schematically indicates an example of the hardware configuration of an in-vehicle device; and

FIG. 6 is a sequence diagram indicating an example of a processing procedure related to generating a guidance text by the system of the present disclosure.

### DESCRIPTION OF THE EMBODIMENTS

Guidance information for road rest facilities such as service areas and parking areas is generally generated manually. However, with the spread of electric vehicles such as BEV (Battery Electric Vehicle), charging facilities are frequently renewed (for example, new construction, etc.) at road rest facilities. Manually updating the guidance information in response to frequent updates to the charging facility can be very costly.

On the other hand, the information processing apparatus according to the first aspect of the present disclosure includes a controller. The controller is configured to execute acquiring target image data from a driving recorder of a target vehicle using a charging facility at a target road rest facility, the target image data captured during an interval from when the target vehicle starts entering the target road rest facility to when the target vehicle arrives at the charging facility, performing image analysis on the acquired target image data, generating a guidance text to the charging facility at the target road rest facility according to a result of the image analysis, and storing the generated guidance text for providing to a user who uses the target road rest facility.

According to the first aspect of the present disclosure, at least a part of the work of generating guidance information to the charging facility is automated by utilizing the target image data obtained by the driving recorder of the target vehicle that visited the target road rest facility. Thereby, it can be expected to reduce the cost of generating guidance information.

As another form of the information processing apparatus (computer) according to the above aspects, one aspect of the present disclosure may be an information processing method that realizes all or part of each of the above components, may be an information processing system, may be a program, or may be a storage medium readable by a machine such as a computer that stores such a program. Here, the machine-readable storage medium may be a non-transitory medium that stores information such as a program by electrical, magnetic, optical, mechanical or chemical action. The non-transitory storage medium may include a storage medium (CD, DVD, semiconductor memory, etc.), an auxiliary storage device of a computer, an external storage device connected to a computer, and the like. The information processing system may be composed of multiple computers, such as server devices and in-vehicle devices.

For example, the information generation method (information processing method) according to the second aspect of the present disclosure is executed by a computer. The information generation method comprises acquiring target image data from a driving recorder of a target vehicle using a charging facility at a target road rest facility, the target image data captured during an interval from when the target vehicle starts entering the target road rest facility to when the target vehicle arrives at the charging facility, performing image analysis on the acquired target image data, generating a guidance text to the charging facility at the target road rest facility according to a result of the image analysis, and storing the generated guidance text for providing to a user who uses the target road rest facility.

Further, for example, the system according to the third aspect of the present disclosure includes a server device and an in-vehicle device deployed in a target vehicle. The in-vehicle device is configured to execute, when the target vehicle is charged at a charging facility at a target road rest facility, extracting a target image data from an image data stored in a driving recorder of the target vehicle, the target image data captured during an interval from when the target vehicle starts entering the target road rest facility to when the target vehicle arrives at the charging facility, and transmitting the extracted target image data to the server device. The server device is configured to execute receiving the target image data from the in-vehicle device, performing image analysis on the received target image data, generating a guidance text to the charging facility at the target road rest facility according to a result of the image analysis, and storing the generated guidance text for providing to a user who uses the target road rest facility.

### 1 Application Example

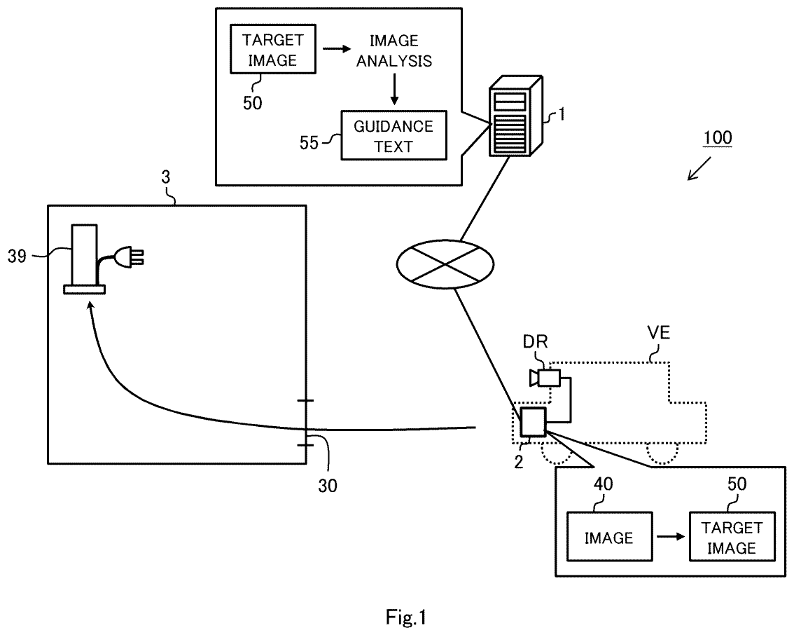

FIG. 1 schematically indicates an example of a situation in which the present disclosure is applied. The system 100 according to this embodiment includes an in-vehicle device 2 installed in a target vehicle VE and a server device 1. The number of in-vehicle devices 2 (target vehicle VE) included in the system 100 may be appropriately determined according to the embodiment.

The in-vehicle device 2 according to the present embodiment is one or more computers configured to provide image data obtained by a driving recorder to a server device. In this embodiment, when the target vehicle VE charges at a charging facility 39 at a target road rest facility 3, the in-vehicle device 2 extracts target image data 50 captured during an interval from when the target vehicle VE starts entering the target road rest facility 3 to when it arrives at the charging facility 39 from the image data 40 stored in the driving recorder DR of the target vehicle VE. The in-vehicle device 2 transmits the extracted target image data 50 to the server device 1. The in-vehicle device 2 may be an in-vehicle equipment that is always deployed in the vehicle, or may be a user terminal that is at least temporarily deployed in the vehicle. The type of in-vehicle device 2 may be appropriately selected according to the embodiment.

On the other hand, the server device 1 according to this embodiment is one or more computers configured to generate a guidance text of a facility from image data. The server device 1 is an example of the information processing apparatus of the present disclosure. In this embodiment, the server device 1 receives the target image data 50 from the in-vehicle device 2. Receiving the target image data 50 is an example of acquiring the target image data 50. The server device 1 performs image analysis on the received target image data 50. The server device 1 generates a guidance text 55 to the charging facility 39 at the target road rest facility 3 according to the result of image analysis. The server device 1 stores the generated guidance text 55 to provide to a user who uses the target road rest facility 3.

According to the system 100 of this embodiment, by utilizing target image data 50 captured by the driving recorder DR of the target vehicle VE visiting the target road rest facility 3, at least a portion of the work of generating guidance information (guidance text 55) to the charging facility 39 is automated. Thereby, it can be expected to reduce the cost of generating guidance information.

### (Driving Recorder)

The driving recorder DR is configured to observe the situation outside the target vehicle VE and record the observation result in image format data. As long as it is possible to detect objects present while the target vehicle VE is moving from the entrance 30 of the road rest facility 3 to the charging facility 39, the type of driving recorder DR does not need to be particularly limited and may be selected appropriately depending on the embodiment. The driving recorder DR may include any sensor that acquires data in an image or image representation. In an exemplary example, the driving recorder DR may be a video recorder.

Further, if it is possible to observe the situation outside the target vehicle VE, the arrangement of the driving recorder DR may not be particularly limited, and may be appropriately determined according to the embodiment. In an exemplary example, the driving recorder DR may be installed near the upper center of the windshield in the target vehicle VE so as to capture the situation in front of the target vehicle VE through the windshield. The driving recorder DR may be permanently deployed on the target vehicle VE or may be deployed temporarily. The in-vehicle device 2 may be temporarily connected to the driving recorder DR when extracting the target image data 50, or may be constantly connected to the driving recorder DR.

### Road Rest Facility

The road rest facility 3 is a rest facility provided adjacent to the road, for example, a service area, a parking area, and the like. Roads are, for example, highways.

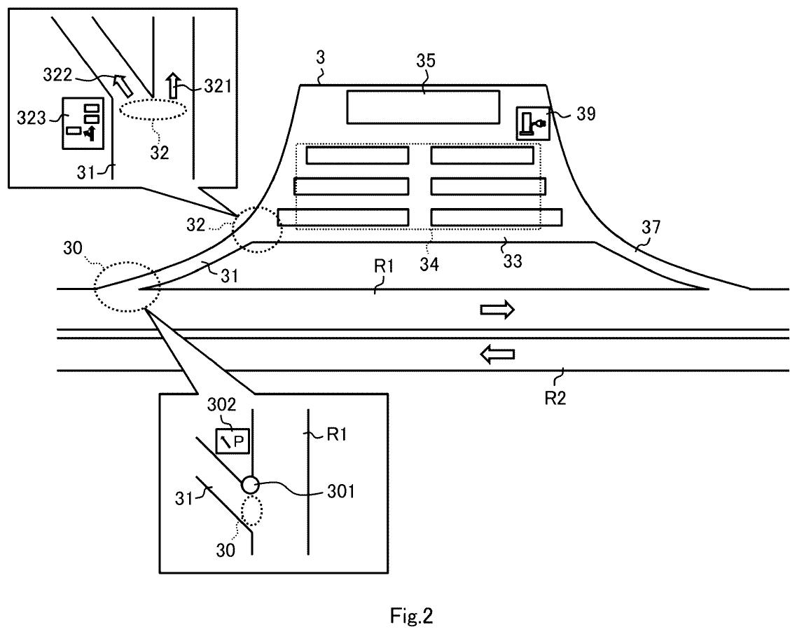

FIG. 2 schematically indicates an example of road rest facility 3. The example in FIG. 2 assumes a scene where the road stipulated for left-hand traffic includes a first roadway R1 and a second roadway R2 separated by a central band, and a road rest facility 3 is provided on the first roadway R1 on the left side. In general, the road rest facility 3 includes an approach road 31, a main area 33, and an exit road 37.

The approach road 31 is used when entering the main area 33 from the main road (in the case of FIG. 2, the first carriageway R1). An entrance (approach entrance) 30 may be provided at the boundary between the approach road 31 and the main road. The entrance 30 constitutes the entrance to the road rest facility 3. A cushion drum 301 may be disposed near a structure (guardrail, wall, etc.) in the vicinity of the entrance 30. Further, a signboard 302 may be disposed around the entrance 30 to indicate the existence of the road rest facility 3 to the driver. The cushion drum 301 and the signboard 302 are examples of landmarks at the entrance 30.

The main area 33 is an area used for resting users. Various facilities may be provided in the main area 33. For example, the main area 33 may include a parking lot 34, a predetermined facility 35, and a charging facility 39. The parking lot 34 is a space for parking vehicles. In one example, the area of the parking lot 34 may be divided by vehicle type such as a motorcycle, a small car, a large vehicle, a trailer, and the like. The predetermined facility 35 may be a building used by visitors. The type of predetermined facility 35 may be arbitrarily selected. The predetermined facility 35 may include, for example, a commercial facility, a rest facility, a gas station, and the like. The commercial facility may include, for example, a restaurant, a shop, and the like. The rest facility may include, for example, a toilet facility or the like. The charging facility 39 is used to charge a battery mounted on an electric vehicle. The electric vehicle may include a plug-in hybrid vehicle. The type of charging facility 39 may be arbitrarily selected. The charging facility 39 may include, for example, a normal charger, a quick charger, and the like. The installation location of the charging facility 39 may be appropriately determined according to the embodiment. In one example, the charging facility 39 may be disposed in the vicinity of a predetermined facility 35, such as in front of the predetermined facility 35, near the predetermined facility 35, ahead of the predetermined facility 35, etc.

In addition, the main area 33 may be provided with a number of lanes extending in the directions of each area of the parking lot 34, predetermined facilities 35, charging facilities 39, and other locations. Accordingly, a branch point 32 may be provided in the vicinity of the place where the approach road 31 joins the main area 33. The branch point 32 may be a point where a plurality of lanes branch from one lane (approach road 31). A predetermined display object may be placed in and around the branch point 32. The display object may be appropriately configured to display arbitrary information such as guidance in each direction (branch destination). In one example, the predetermined display object may include at least one of a road surface indications (321, 322) and a display plate 323.

Road surface indications (321, 322) are applied to the road surface. The road surface indications (321, 322) may include, for example, indications guiding in various directions, road markings, partition lines, and the like. The display plate 323 may be, for example, a signboard such as a guide for each direction or a sign. The display of the guide for each direction may include a display indicating each area of the parking lot (“small vehicle”, “large vehicle”, etc.). In the example of FIG. 2, the road surface indications (321, 322) is disposed around the start point of each lane after branching, and the display plate 323 is disposed outside the vicinity of branch point 32. However, the placement location of the road surface indications (321, 322) and the display plate 323 may not be limited to such examples. The road surface indications (321, 322) and the display plate 323 may be disposed at any location around the branch point 32 and branch point 32, respectively. The road surface indications (321, 322) and the display plate 323 are examples of display objects. The display object is an example of a branch point 32 landmark.

The exit road 37 is used when exiting from the main area 33 to the main road. An exit may be provided at the boundary of the exit road 37 and the main road. The exit constitutes an exit of the road rest facility 3. Each vehicle, including the target vehicle VE, may enter the main area 33 via the approach road 31 from the main road. The user may park the vehicle in the parking lot 34 of the main area 33 and take a break as appropriate by using the predetermined facility 35. Thereafter, each vehicle may rejoin the main road from the main area 33 via the exit road 37. The configuration of the road rest facility 3 may not be limited to the example of FIG. 2 and may be changed arbitrarily. With respect to the configuration of the road rest facility 3, components may be omitted, replaced, and added as appropriate.

(Determination of Whether or not the Charging Facility has been Used)

Whether or not the target vehicle VE has used the charging facility 39 at the target road rest facility 3 may be determined by any method. In one example, it may be specified that the target vehicle VE used the charging facility 39 by the user's declaration. The user's declaration may be made, for example, by the operation of the in-vehicle device 2. In another example, whether or not the target vehicle VE has used the charging facility 39 may be determined by any information processing.

As an example of the determination process, whether or not the target vehicle VE has used the charging facility 39 may be determined by analyzing vehicle data. For example, the positioning module may measure the position of the target vehicle VE. The positioning module may be configured of a GPS (Global Positioning Satellite) module, a GNSS (Global Navigation Satellite System) module, or the like. The positioning module may be provided in the target vehicle VE, the in-vehicle device 2, or another computer (a user terminal other than the in-vehicle device 2, etc.). Depending on the position information obtained by the positioning module, it may be determined whether the target vehicle VE has entered the target road rest facility 3 or not. In addition, it may be determined whether or not the target vehicle VE has used the charging facility 39 according to whether or not the charging amount has been increased by the battery information (State Of Charge (SOC), etc.) of the target vehicle VE.

As another example of the determination process, it may be determined whether or not the target vehicle VE has used the charging facility 39 by analyzing the image data obtained by the driving recorder DR. For example, depending on whether or not an object existing in the target road rest facility 3 is detected in the image data, it may be determined whether or not the target vehicle VE has used the charging facility 39. The object of the target road rest facility 3 may include, for example, a marker of the entrance 30 (cushion drum 301, signboard 302, etc.), a marker of the branch point 32 (display object, etc.), a predetermined facility 35, a charging facility 39, and the like.

The subject that executes the determination process may not be particularly limited, and may be appropriately selected according to the embodiment. Each of the above determination processes may be executed by any computer.

In one example, the in-vehicle device 2 may determine whether or not the target vehicle VE has used the charging facility 39 by executing the above-mentioned determination process. The in-vehicle device 2 may execute the determination process as a spontaneous operation or in response to a request from the server device 1. When it is determined that the target vehicle VE has used the charging facility 39, the in-vehicle device 2 may extract target image data 50 captured during the interval from when the target vehicle VE starts entering the target road rest facility 3 to when it arrives at the charging facility 39 from the image data 40 stored by the driving recorder DR of the target vehicle VE. Then, the in-vehicle device 2 may transmit the extracted target image data 50 to the server device 1. If it is determined that the target vehicle VE does not use charging facility 39, in-vehicle device 2 is The transmission process of the target image data 50 may be omitted.

In another example, the server device 1 may acquire data from the target vehicle VE (in-vehicle device 2). The server device 1 may determine whether the target vehicle VE has used the charging facility 39 by performing the above determination process with using the acquired data. The server device 1 may transmit a signal requesting the provision of the target image data 50 to the target vehicle VE (or the in-vehicle device 2) that is determined to have used the charging facility 39. In response to the request signal, the in-vehicle device 2 may extract the target image data 50 from the image data 40 and transmit the extracted target image data 50 to the server device 1. Note that the process of extracting the target image data 50 does not necessarily have to be executed by the in-vehicle device 2. The in-vehicle device 2 or the driving recorder DR may transmit at least a part of the image data 40 including the target image data 50 to the server device 1. The server device 1 may extract the target image data 50 from at least a part of the acquired image data 40.

In yet another example, another computer (other server device, etc.) other than the server device 1 and the in-vehicle device 2 may perform the above determination process to determine whether or not the target vehicle VE has used the charging facility 39. The other computer may give an instruction to transmit the target image data 50 to the target vehicle VE (or the in-vehicle device 2) that is determined to have used the charging facility 39. In response to an instruction from an external computer, the in-vehicle device 2 may extract the target image data 50 from the image data 40 and transmit the extracted target image data 50 to the server device 1. The external computer may provide the server device 1 with a command to request the in-vehicle device 2 to transmit the target image data 50. Further, when the in-vehicle device 2 or the driving recorder DR provides at least a part of the image data 40 including the target image data 50 to the external computer in advance, the external computer extracts the target image data 50 and the extracted target image data 50 may be provided to the server device 1. Alternatively, the external computer may provide at least a part of the image data 40 to be held to the server device 1 and cause the server device 1 to execute the extraction of the target image data 50.

### Target Image Data

The target image data 50 is composed of image data captured by the driving recorder DR during at least a portion of the time from when the target vehicle VE starts entering the target road rest facility 3 to when it arrives at the charging facility 39. In one example, the target image data 50 may be composed of image data covering the entire period from the start of entry into the target road rest facility 3 to the arrival at the charging facility 39. In another example, the target image data 50 may be composed of image data for a portion of time (interval).

The point when the target vehicle VE starts to enter the target road rest facility 3 may be defined at any point when the target vehicle VE is travelling around the entrance 30. In one example, the point when the target vehicle VE starts to enter the target road rest facility 3 may be defined at the point when the target vehicle VE passes through the entrance 30, or the point when the target vehicle VE arrives the front of the entrance 30. The front of the entrance 30 may be defined based on the entrance 30 as follows, for example, X seconds before passing through the entrance 30, a position before Dx [m] from the entrance 30, and the like. The reference values (X seconds, Dx [m]) may be set arbitrarily. The reference value may be a fixed value or a variable value (for example, a value determined according to the running speed of the target vehicle VE). The point at which the charging facility 39 arrives may be defined based on the charging facility 39, such as, for example, when the target vehicle VE is stopped in front of the charging facility 39.

As long as the target vehicle VE includes image data for at least a part of the time from the start of the approach to the target road rest facility 3 to the arrival at the charging facility 39, the configuration of the target image data 50 may not be particularly limited, and may be appropriately determined according to the embodiment. In one example, the target image data 50 may include image data (may be referred to as interval image data) in each of the one or more intervals defined from the time the target vehicle VE starts entering the target road rest facility 3 until it arrives at the charging facility 39. Further, the target image data 50 may further include image data in an interval other than the time from the start of the approach to the arrival, such as before the target vehicle VE enters the target road rest facility 3. The target image data 50 may be composed of a plurality of still images or may be composed of moving images. If the driving recorder DR comprises the microphone, the target image data 50 may further include sound data obtained with the image data. The sound data may be omitted.

The target image data 50 may be extracted from the image data 40 stored in the driving recorder DR by any method. In one example, at least one of the target vehicle VE and the in-vehicle device 2 may include a timer, and vehicle data related to the running of the target vehicle VE may be recorded together with the time. Correspondingly, a time based on extraction may be specified from the vehicle data. For example, the occurrence of an event related to the use of the charging facility 39 may be identified from the vehicle data. The event may include a characteristic event from the start of the approach to the target road rest facility 3 to the arrival at the charging facility 39, such as the target vehicle VE being located in front of the entrance 30, passing through the entrance 30, passing through the branch point 32, parking the target vehicle VE in front of the charging facility 39, and the like. Events related to the position of an object other than the charging facility 39, such as the target vehicle VE being located in front of the entrance 30, passing through the entrance 30, or passing through the branch point 32, may be identified from the position information obtained by the positioning module. For example, the time identified from the position information that the target vehicle VE is located at the entrance 30 may be specified as the time when the target vehicle VE passes through the entrance 30. Events related to charging, such as stopping the target vehicle VE in front of the charging facility 39, may be identified from the battery information. For example, the time immediately before the charge amount of the target vehicle VE increases may be identified from the battery information, and the identified time may be specified as the time when the target vehicle VE is parked before the charging facility 39. Note that the method for specifying the occurrence time of each event may not be limited to these examples, and may be appropriately changed according to the embodiment. For example, the time when the ignition is turned off in front of the charging facility 39 may be identified as the time when the target vehicle VE is parked in front of the charging facility 39. Then, based on the occurrence time of the identified event, an interval for extracting the target image data 50 from the image data 40 may be specified. In another example, the time based for extraction may be specified from the image data 40 itself. For example, the occurrence of each of the above events may be identified by image analysis, and an interval to be extracted as the target image data 50 based on the occurrence time of the identified event may be specified.

The process of extracting the target image data 50 may be executed in connection with the determination process for determining whether or not the target vehicle VE has used the charging facility 39 at the target road rest facility 3, or may be executed independently of the determination process. In one example, the process of extracting the target image data 50 may be executed at least partially in common with the determination process. For example, depending on whether or not the occurrence of each event of passing through the entrance 30 and charging at the charging facility 39 is detected, it may be determined whether or not the target vehicle VE has used the charging facility 39 at the target road rest facility 3. Further, the target image data 50 may be extracted from the accumulated image data 40 based on the occurrence time of each detected event. In another example, the process of extracting the target image data 50 may be executed separately from the determination process.

How in-vehicle device 2 sends target image data 50 to server device 1 It may not be particularly limited and may be appropriately selected according to the embodiment. In one example, the in-vehicle device 2 may directly transmit the target image data 50 to the server device 1. Thereby, the server device 1 may directly acquire the target image data 50 from the in-vehicle device 2. In another example, the in-vehicle device 2 may transmit the target image data 50 to a storage area other than the server device 1 such as a storage medium or another computer. The other computer may include a data server such as NAS (Network Attached Storage). In response to this, the server device 1 may indirectly acquire the target image data 50 via a storage medium, another computer, or the like. The same method may be used to transmit at least part of the image data 40 including the target image data 50 from the driving recorder DR or in-vehicle device 2 to the server device 1 or another computer when the process of extracting the target image data 50 is not performed by the in-vehicle device 2.

### (Sorting)

The target vehicle VE may be any vehicle that uses the charging facility 39 at the target road rest facility 3. That is, the target image data 50 may be obtained from any vehicle using the charging facility 39 at the target road rest facility 3. In a typical example, the target image data 50 may be acquired from a vehicle that uses a charging facility (charging facility 39) that is not present in the map information, or that is present in the map information but for which no guidance information exists.

Further, in an example of the present embodiment, it may be determined whether or not the imaging conditions in the vehicle satisfy the predetermined conditions. The target image data 50 used to generate the guidance text 55 may be obtained from a vehicle whose photographing conditions are determined to satisfy predetermined conditions. That is, according to whether or not the photographing conditions meet the predetermined conditions, the target vehicle VE for acquiring the target image data 50 for generating the guidance text 55 may be selected. Predetermined conditions may be appropriately defined to be suitable for image processing when generating the guidance text 55 (for example, it is easy to detect an object). In one example, the predetermined condition may include at least one of the visibility conditions of the driving recorder DR, the running conditions of the vehicle, and the type of vehicle.

The visibility conditions of the driving recorder DR may be appropriately defined to extract a vehicle for which the driving recorder DR has a good visibility. In one example, the visibility conditions of the driving recorder DR may be defined according to at least one of the weather when visiting the target road rest facility 3 and the imaging environment of the driving recorder DR. For example, the weather-related visibility condition may be defined to extract the vehicle visited to the target road rest facility 3 during weather other than weather that obstructs the view. The weather that obstructs the view may be, for example, rain, fog (including dense fog), snow, hail, and the like. Weather conditions may be determined by weather information in the area of the target road rest facility 3. Weather information may be appropriately acquired from an external server that provides weather information.

The visual conditions related to the imaging environment may be defined to extract a vehicle in which imaging by the driving recorder DR is performed in an environment other than an environment that blocks the view.

The environment that obstructs the view may include, for example, that the lens or lens cover of the driving recorder DR is dirty, that there is an obstacle that blocks the view in the imaging range of the driving recorder DR, and the like. If the driving recorder DR is positioned to capture an image of the outside of the vehicle through the windshield, determining whether or not there is an obstacle obstructing the view may include determining whether or not the windshield is dirty. The conditions related to the imaging environment may be determined from the image obtained by the driving recorder DR.

Further, when the vehicle is traveling at a high speed, blurring of the object in the image obtained by the driving recorder DR may occur, which may result in a decrease in the accuracy of the image analysis. Therefore, the driving conditions of the vehicle may be defined to extract a vehicle traveling at a speed less than a threshold value for the time interval for acquiring the target image data 50. The speed threshold may be set arbitrarily. The running conditions of the vehicle may be determined according to the travel speed data of the vehicle. The traveling speed data may be appropriately acquired from the target vehicle VE.

In addition, many vehicles that use the Road Rest Facility are small vehicles. By using the image data obtained from the small car to generate the guidance text 55, it can be expected that the guidance text 55 can be generated from a viewpoint similar to that of many vehicles using road rest facilities. Therefore, the type condition of the vehicle may be defined so as to extract a small car. The type condition of the vehicle may be determined according to the attribute information of the vehicle. Attribute information of the vehicle may be acquired as appropriate. In addition, a small vehicle may be appropriately defined as belonging to a general vehicle. For example, a small car may be defined as a vehicle having a length of 4.7 m or less, a width of 1.7 m or less, and a height of 2.0 m or less.

The predetermined conditions may include at least one of the above conditions. In one example, the predetermined conditions may include all of the visibility conditions of the driving recorder DR, the driving conditions of the vehicle, and the type of vehicle. In this case, the target image data 50 used for generating the guidance text 55 can be obtained from a vehicle that is a small vehicle in which the visibility condition satisfies the condition of good visibility, the running speed is less than the threshold value. If the predetermined condition includes at least one of the above visibility conditions and the driving conditions, the target image data 50 suitable for image analysis can be acquired. Thereby, it can be expected that the generation accuracy of the guidance text 55 will be improved. Further, when the predetermined condition satisfies the vehicle type condition, it is possible to acquire target image data 50 with a view similar to that of many vehicles using the target road rest facility 3. Thereby, it can be expected to generate a guidance text 55 suitable for many users.

The process of sorting the target vehicle VE according to the imaging conditions may be executed at any timing. In one example, selecting a target vehicle VE from which to obtain target image data 50 for generating guidance text 55 may be performed by acquiring image data from all vehicles and then selecting image data from the acquired image data that satisfies the conditions as the target image data 50. In another example, selecting the target vehicle VE may consist of selecting vehicles that meet conditions from vehicles that have visited the target road rest facility 3 before acquiring the image data, and acquiring the target image data 50 from the selected vehicles.

Further, the process of selecting the target vehicle VE according to the imaging conditions may be executed by any computer. Similar to the above determination process for determining whether or not the target vehicle VE has used the charging facility 39 in the target road rest facility 3, the process of selecting the target vehicle VE may be executed by at least one of the in-vehicle device 2, the server device 1, and another computer.

Note that the process of selecting the target vehicle VE according to the imaging conditions may be omitted. In another example, the target vehicle VE for which the target image data 50 is acquired may be randomly selected from the vehicle using the charging facility 39 at the target road rest facility 3. In yet another example, the target image data 50 may be acquired from all vehicles that use the charging facility 39 at the target road rest facility 3.

### (Image Analysis)

The content of the image analysis for the target image data 50 may be appropriately determined according to the embodiment. In one example, the image analysis on the target image data 50 may include detecting an object appearing in the target image data 50, estimating the position of the object, estimating the distance of the object, estimating the positional relationship between a plurality of objects, identifying the type of object, and the like. The object may be, for example, a marker of the entrance 30 (cushion drum 301, signboard 302, etc.), a landmark of the branch point 32 (display object, etc.), a predetermined facility 35, a charging facility 39, and the like.

Further, the method of image analysis for the target image data 50 may be appropriately selected according to the embodiment. In one example, the server device 1 may analyze the target image data 50 by a general image analysis method such as edge detection and pattern matching. In another example, the server device 1 may perform image analysis on the target image data 50 using a trained machine learning model that has acquired the ability to analyze the image. The machine learning model is configured to have one or more operation parameters that can be adjusted by machine learning. One or more operation parameters are used for the operation of the target inference (image analysis, etc.). The machine learning model may be configured by, for example, a neural network, a support vector machine, other functional expressions (arithmetic models), and the like. The machine learning method may be appropriately selected according to the machine learning model to be adopted (for example, error backpropagation method, etc.). Training a machine learning model is to use training samples to adjust (optimize) the values of the computational parameters. When the machine learning model is given an image of the training sample, it may be appropriately trained to derive the true value of the corresponding analysis result. A large-scale model such as a large visual language model (VLM: Vision Language Model) may be used as the trained machine learning model. When the target image data 50 includes sound data, the image analysis for the target image data 50 may include sound analysis for the sound data.

### (How to Generate Guidance Text)

The guidance text 55 may be appropriately generated from the results of image analysis on the target image data 50. In a typical example, the server device 1 may detect objects captured while the target vehicle VE moves from the entrance 30 to the charging facility 39. The server device 1 may generate guidance text 55 that provides guidance about the charging facility 39 based on the detected object. That is, the guidance text 55 may be generated to guide the vehicle to the charging facility 39 based on the objects observed by the driving recorder DR from the entrance 30 to the charging facility 39. The object (object) that serves as the reference for the guidance may be appropriately selected according to the embodiment. Further, the result of the image analysis may be appropriately applied to the generation of the guidance text 55. For example, in image analysis, when identifying an object, the server device 1 may generate a guidance text 55 including the name of the identified object, such as “The charging facility is in front of the AAA facility” or the like. Also, for example, when estimating the distance to an object in image analysis, the server device 1 may generate a guidance text 55 including the estimated distance, such as “The charging facility is located approximately XX m before the AAA facility.” Further, for example, when estimating the positional relationship between the charging facility 39 and the object in image analysis, the server device 1 may generate a guidance text 55 including an estimated positional relationship, such as “The charging facility is on the right side of the AAA facility.”

The method for generating the guidance text 55 may not be particularly limited, and may be appropriately selected according to the embodiment. In one example, the guidance text 55 may be generated on a rule-based basis. When the rule base is adopted, the server device 1 may generate guidance text 55 from the result of image analysis according to the rule. The rules for generation may be set appropriately. When generating the guidance text 55, a template such as a fixed text may be used. Generating a guidance text 55 using a template may include at least one of selecting a fixed text to be used from a plurality of prepared fixed texts according to the results of image analysis, and inputting the result of image analysis at a designated place of the fixed text. Further, the plurality of standard texts prepared may include, for example, a fixed text that is used as it is, such as “charging facility is.” The template may be held in the memory resources of server device 1, provided by an external computer, or incorporated into a program of server device 1.

In another example, a trained machine learning model may be used to generate the guidance text 55 as well as the image analysis. The machine learning model may be configured as described above. When a trained machine learning model is used for both image analysis and generation of guidance text 55, the machine learning model used for image analysis and the machine learning model used for generating guidance text 55 may be separate or may be the same.

When the former is employed, the first machine learning model used for image analysis may be configured to accept an input of image data (target image data 50) and output the result of image analysis for the input image data. The second machine learning model used to generate the guidance text 55 may be configured to accept the input of the image analysis result and output the generation result of the guidance text 55 according to the input image analysis result. Each machine learning model may be configured to further accept arbitrary information input in addition to the above input. Further, a dedicated model may be employed for each machine learning model. Each dedicated model may be appropriately trained to acquire the ability to perform each of the above inference processes (image analysis, generation of guidance text 55). Alternatively, each machine learning model may be composed of a general-purpose model such as a large visual language model or a large language model (LLM). In one example, a large visual language model may be used as the first machine learning model, and a large language model may be used as the second machine learning model. Large-scale models, such as large visual language models and large language models, have acquired the ability to perform in-context learning. When using a machine learning model capable of performing such in-context learning, the server device 1 may provide a pre-prompt, such as an instruction on the inference content, to the machine learning model together with the input information. As an example, when a large visual language model is adopted as the first machine learning model, the server device 1 may provide inference instructions such as “Detect objects existing around the charging facility” or “Identify the type of object” to the first machine learning model together with the target image data 50. When a large language model is employed as the second machine learning model, the server device 1 may provide an inference instruction such as “Generate a guidance text to the charging facility from the given information” to the second machine learning model together with the result of image analysis. Each inference instruction may be given appropriately in a template or the like.

On the other hand, when the latter is employed, the machine learning model may be configured to accept the input of image data (target image data 50) and output the generation result of guidance text 55 according to the input image data. That is, the machine learning model may be configured as an end-to-end model. In this case, performing image analysis on the target image data 50 and generating guidance text 55 according to the result of image analysis may be executed simultaneously in the operation of the machine learning model. As above, a dedicated model may be used for the machine learning model, or a general-purpose model may be used. The machine learning model may be composed of a model that has the ability to perform in-context learning, such as a large visual language model. When using a machine learning model having the ability to perform in-context learning, the server device 1 may provide a preprompt such as an instruction of inference content to the machine learning model together with input information. As an example, when a large-scale visual language model is adopted as the machine learning model, the server device 1 may provide the machine learning model with inference instructions such as “(I) Detect objects present around the charging facility. (II) Generate guidance text to the charging facility from the detection results of (I)” along with the target image data 50. Inference instructions may be given appropriately in a template or the like.

In the road rest facility 3 exemplified in FIG. 2, the vehicle generally enters the road rest facility 3 from the entrance 30 and heads to the charging facility 39 via the branch point 32. Therefore, the generated guidance text 55 may include at least one of the first part text that guides the charging facility 39 from the range from the entrance 30 to the branch point 32, and the second part text that guides the location of the charging facility 39 in the range from the branch point 32 onward. The location of the charging facility 39 may be shown, for example, by a positional relationship with a predetermined facility 35. In both the case where the rule base is adopted and the case where the machine learning model is used, the server device 1 may generate at least one of the first part text and the second part text. The first part text may be generated from the results of image analysis for image data up to about branch point 32. The second part text may be generated from the results of image analysis on the image data from passing through the branch point 32 to arriving at the charging facility 39. The first part text may be used to guide the location of the charging facility 39 based on a position somewhat away from the charging facility 39. The second part text may be used to indicate the location of the charging facility 39 based on the location close to the charging facility 39.

When providing the guidance text 55 generated to the user who uses the target road rest facility 3 after the target vehicle VE, the timing of outputting the generated guidance text 55 may be arbitrarily defined. In one example, the timing at which the guidance text 55 is output may be uniformly defined such as the timing of passing through the entrance 30. However, the scale of the road rest facility 3 may vary depending on the location. In particular, the length of the approach road 31 may differ. Even if the guidance text 55 is output at a large distance from the main area 33, there is a large discrepancy between the information guided by the guidance text 55 and the current position, and it may be difficult to grasp the location of the charging facility 39. Therefore, the server device 1 may set the output timing of the guidance text 55 according to the time length in an arbitrary interval in the target image data 50. That is, generating the guidance text 55 may include setting the output timing of the guidance text 55 when providing the guidance text 55 to the user. The interval that serves as a reference for the output timing may be appropriately defined according to the embodiment. For example, the interval that serves as a reference for the output timing may be defined in at least a portion of the interval from before the entrance 30 to around the branch point 32.

As described above, the guidance text 55 (each part text) may be generated according to a part interval (specific interval) in the process from the target vehicle VE to the target road rest facility 3 from the entrance 30 to the arrival at the charging facility 39. Similarly, the output timing setting may be defined according to some intervals. Therefore, one or more specific intervals may be extracted during the time that the target vehicle VE travels from just before the entrance 30 to the charging facility 39. Each interval may be extracted in any way. In one example, each interval may be extracted by appropriately dividing the travel time from the entrance 30, or by specifying a range that satisfies the condition.

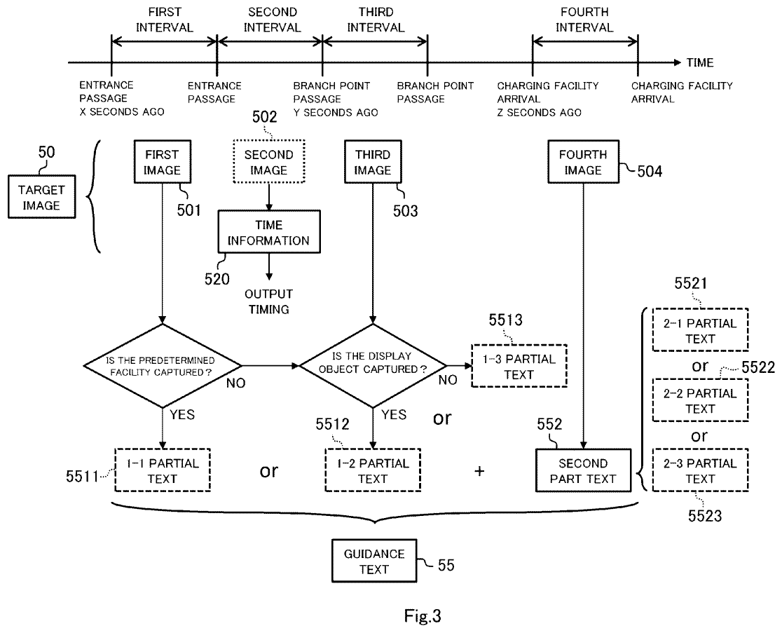

FIG. 3 schematically indicates an example of the time lapse from the vicinity of the entrance 30 to the arrival at the charging facility 39 and the extracted interval. In the example of FIG. 3, a scene is assumed in which the target vehicle VE enters the road rest facility 3 illustrated in FIG. 2 from an entrance 30, and travels via an approach road 31 and a branch point 32 to a charging facility 39.

In one example, in the process (time) of moving from the entrance 30 before the entrance 30 to the charging facility 39, the first interval from before the entrance 30 of the target road rest facility 3 to passing through the entrance 30 may be extracted. The first interval may be extracted by any method. For example, as described above, the point at which the target vehicle VE passes through the entrance 30 may be specified by location information, image analysis, and the like. The point at which the target vehicle VE is located in front of the entrance 30 may be appropriately specified based on the specified time at which the target vehicle VE passes through the entrance 30. In one example, as shown in FIG. 3, the time point before the entrance 30 may be specified based on the passage time of the entrance 30 (X seconds before passing through the entrance 30). In another example, a time point before the entrance 30 may be specified based on the point of passage of the entrance 30 by a criterion other than time (for example, distance, etc.). The time point before the entrance 30 may be specified without using the point of passage of the entrance 30 as a reference. For example, the point before the entrance 30 may be specified by position information, image analysis (whether or not the entrance 30 is captured, etc.). Thereby, the first interval can be extracted.

When extracting the first interval, the target image data 50 may include the first image data 501 captured in the first interval. The first image data 501 may be referred to as the first interval image data. The image analysis on the target image data 50 may include determining whether or not the predetermined facility 35 is captured in the first image data 501. When the predetermined facility 35 is shown in the first image data 501, the generated guidance text 55 may include a text (1-1 partial text 5511) that guides the charging facility 39 in the direction based on the predetermined facility 35. The 1-1 partial text 5511 is an example of the first part text. The 1-1 partial text 5511 may be composed of one or more phrases that guide the user toward the charging facility 39 based on a predetermined facility 35, such as “Proceed toward the AAA facility.” The charging facility is often placed around the predetermined facility. According to an example of the present embodiment, in a case where a predetermined facility 35 can be seen in the initial range of entering the target road rest facility 3, a guidance text 55 (1-1 partial text 5511) that guides the charging facility 39 based on the predetermined facility 35 can be generated. Thereby, it can be expected to generate a guidance text 55 that can be appropriately guided to the charging facility 39.

Further, in one example, in the process of moving from the entrance 30 before the entrance 30 to the charging facility 39, a third interval including the branch point 32 of the target road rest facility 3 may be extracted. The third interval may be appropriately defined around the branch point 32 so as to include the range in which the displayed object may be captured. As shown in FIG. 3, in one example, the third interval may be defined as a range from a point located before the branch point 32 to the point of passing through the branch point 32. The third interval may include an area beyond the branch point 32. The third interval may be extracted by any method. For example, as described above, the time when the target vehicle VE passes through the branch point 32 may be determined by position information, image analysis, etc. The point at which the target vehicle VE is located in front of the branch point 32 may be appropriately specified based on the specified time at which the target vehicle VE passes through the branch point 32. In one example, as shown in FIG. 3, the point before branch point 32 may be specified based on the passage time of branch point 32 (Y seconds before passing through branch point 32). In another example, a time point before the branch point 32 may be specified based on the point of passage of the branch point 32 by a criterion other than time (e.g., distance, etc.). The point before the branch point 32 may be specified without using the point of passage of the branch point 32 as a reference. For example, the point in time just before the branch point 32 may be identified by position information, image analysis (such as detection of a display object), or the like. Thereby, the third interval can be extracted.

When extracting the third interval, the target image data 50 may further include the third image data 503 captured in the third interval. The third image data 503 may be referred to as the third interval image data. The image analysis on the target image data 50 may include determining whether or not a predetermined display object is captured in the third image data 503. The predetermined display object may be, for example, the road surface indications (321, 322), the display plate 323, and the like. When the predetermined facility 35 is not shown in the first image data 501 and the predetermined display is shown in the third image data 503, the generated guidance text 55 may include a text (1-2 partial text 5512) that guides the charging facility 39 based on the predetermined display object. The 1-2 partial text 5512 is an example of the above first part text. The 1-2 partial text 5512 may be composed of one or more phrases that guide the user toward the charging facility 39 by indicating which of the multiple lanes extending from the branch point 32 leads to the charging facility 39, such as “Proceed toward the BBB area.” When a plurality of display objects exist, a display that matches the direction of travel of the target vehicle VE toward the charging facility 39 may be appropriately selected from the displays indicated by each display. The selected display may be, for example, a display located in the direction of travel of the target vehicle VE, a display guiding the direction of travel of the target vehicle VE, and the like. In branch point 32, the route is divided into a plurality of lanes. Therefore, if predetermined facility 35 is not visible in the initial range of the approach, branch point 32 is reached user can get lost in choosing a lane to reach charging facility 39. On the other hand, according to an example of the present embodiment, when the predetermined facility 35 is not visible in the initial range of the approach, a guidance text 55 (1-2 partial text 5512) that guides the direction of the branch destination at the branch point 32 can be generated. Thereby, it can be expected to generate a guidance text 55 that can be appropriately guided to the charging facility 39.

If the predetermined facility 35 is not detected in the first image data 501 and the display object is not detected in the third image data 503, the server device 1 may detect an arbitrary object (target object) from the image obtained from the start point of the first interval to the end point of the third interval. The target may be appropriately selected according to the embodiment. For example, server device 1 can be predetermined from images in the range other than the first interval predetermined facility 35 may be detected as a target object. The server device 1 may detect a display object and another object other than the predetermined facility 35 as a target object from the image obtained from the start point of the first interval to the end point of the third interval. The image analysis on the target image data 50 may include determining whether or not the target object is captured in the image data from the start point of the first interval to the end point of the third interval. The generated guidance text 55 may include a text (1-3 partial text 5513) that guides the charging facility 39 in the direction of the detected target object. Alternatively, the server device 1 may omit the process of generating the first part text (the 1-3 partial text 5513).

In one example, in the process of moving from the front of the entrance 30 to the charging facility 39, the fourth interval from before the charging facility 39 to the charging facility 39 may be extracted. The fourth interval may be extracted by any method. For example, as described above, the time when the target vehicle VE is stopped at the charging facility 39 may be specified by battery information, image analysis, and the like. The point at which the target vehicle VE is located in front of the charging facility 39 may be appropriately specified based on the time when the target vehicle VE is parked at the charging facility 39. In one example, as shown in FIG. 3, the time point before the charging facility 39 may be specified based on the time when the target vehicle VE is stopped at the charging facility 39 (Z seconds before stopping at the charging facility 39). In another example, a point in front of the charging facility 39 may be specified based on the stop point at the charging facility 39 based on a criterion other than time (for example, distance, etc.). The point in front of the charging facility 39 may be specified by image analysis (such as whether or not the charging facility 39 is shown). Thereby, the fourth interval can be extracted.

When extracting the fourth interval, the target image data 50 may include the fourth image data 504 captured in the fourth interval. The fourth image data 504 may be referred to as the fourth interval image data. Image analysis with respect to the target image data 50 may include estimating the positional relationship between the predetermined facility 35 and the charging facility 39 appearing in the fourth image data 504. The generated guidance text 55 may include a text (second part text 552) that guides the positional relationship of the predetermined facility 35 and the charging facility 39. The positional relationship may be indicated in the direction in which the charging facility 39 exists with reference to the object, such as the right direction of the facility, the left direction of the facility, and the like. The positional relationship may be indicated by a relative position based on the object, such as in front of the facility, near the facility, at the tip of the facility, and the like. If at least one of the predetermined facility 35 and the charging facility 39 is not detected from the fourth image data 504, the process of generating this second part text 552 may be omitted.

The contents of the second part text 552 may be appropriately selected according to the positional relationship of the predetermined facility 35 and the charging facility 39. For example, when it is presumed that the charging facility 39 exists in front of the predetermined facility 35 (the first relationship is established), the server device 1 may generate a 2-1 partial text 5521 that informs the presence of the charging facility 39 in front of the predetermined facility 35 as an example of the second part text 552. The presence in front of the predetermined facility 35 may mean that the charging facility 39 exists at a distance from the predetermined facility 35 on the entrance 30 (branch point 32) side. Further, for example, when it is presumed that the charging facility 39 exists near the predetermined facility 35 (the second relationship is established), the server device 1 may generate a 2-2 partial text 5522 that informs the presence of the charging facility 39 near the predetermined facility 35 as an example of the second part text 552. Presence near the predetermined facility 35 may mean that the charging facility 39 is in the vicinity of the predetermined facility 35. Further, for example, when it is presumed that the charging facility 39 exists beyond the predetermined facility 35 (a third relationship is established), the server device 1 may generate a 2-3 partial text 5523 that informs that the charging facility 39 exists beyond the predetermined facility 35 as an example of the second part text 552. Existing beyond the predetermined facility 35 may mean that the charging facility 39 exists away from the predetermined facility 35 at a position past the predetermined facility 35 as seen from the entrance 30 (branch point 32) side. It may be determined by any method whether the charging facility 39 exists in the vicinity of the predetermined facility 35 or is far away. For example, depending on the location information of the target vehicle VE at the time of stopping and the location information of the predetermined facility 35, it may be determined whether the charging facility 39 is located near or far from the predetermined facility 35. Further, for example, in the fourth image data 504, depending on whether or not the predetermined facility 35 and the charging facility 39 are detected at the same time, it may be determined whether the charging facility 39 exists in the vicinity of the predetermined facility 35 or is far away. Note that the type of the second part text 552 according to the positional relationship may not be limited to the above three, and may be appropriately changed according to the embodiment. The type of the second part text 552 may be set to 2 or less, or may be set to 4 or more. According to an example of the present embodiment, a guidance text 55 (second part text 552) that guides the positional relationship with the predetermined facility 35 can be generated. Thereby, it can be expected to generate a guidance text 55 that can be appropriately guided to the charging facility 39.

Further, in one example, in the process of moving from the entrance 30 before the entrance 30 to the charging facility 39, the second interval from passing through the entrance 30 of the target road rest facility 3 to passing through the branch point 32 may be extracted. The second interval may be appropriately defined between the entrance 30 and the branch point 32 (i.e., the range of the approach road 31). As shown in FIG. 3, in one example, the second interval may be defined as an interval between the end point of the first interval and the start point of the third interval. Thereby, the second interval may be continuous with the first interval and the third interval. In this case, after detecting the first interval and the third interval, the second interval can be easily detected. Note that the definition of the second interval may not be limited to such examples. The second interval may partially overlap with at least one of the first interval and the third interval. The second interval may include the third interval. The second interval may not be contiguous with at least one of the first interval and the third interval. That is, the second interval may be defined to be away from at least one of the end point of the first interval and the start point of the third interval.

When extracting the second interval, the target image data 50 may include time information 520 indicate the time length of the second image data 502 captured in the second interval. The second image data 502 may be referred to as the second interval image data. The target image data 50 may or may not include the second image data 502. Generating the guidance text 55 may include setting the output timing of the guidance text 55 when providing the guidance text 55 to the user according to the time length indicated by the time information 520.

The relationship between the time length of the second interval and the setting of the output timing may be appropriately defined according to the embodiment. For example, if the time length of the second interval is less than the first threshold, the output timing may be set at the time of passing through the entrance 30. When the time length of the second interval exceeds the first threshold value and is less than the second threshold, the output timing may be set at a time when the entrance 30 exceeds D1 [m]. When the time length of the second interval is equal to the first threshold, the output timing may be set to either the time of passing through the entrance 30 or the time when the entrance 30 is exceeded by D1 [m]. When the time length of the second interval exceeds the second threshold, the output timing may be set at a time when the entrance 30 exceeds D2 [m]. When the time length of the second interval is equal to the second threshold, the output timing may be set either at the time when the entrance 30 is exceeded by D1 [m] or when D2 [m] is exceeded. The first threshold value may be appropriately set so that outputting the guidance text 55 at the entrance 30 is suitable for guidance to the charging facility 39. The second threshold may be appropriately set at a value larger than the first threshold. D1 [m] may be appropriately set according to the second threshold. D2 [m] may be appropriately set at a value larger than D1 [m]. Note that the type of output timing according to the time length of the second interval may not be limited to the above three, and may be appropriately changed according to the embodiment. The type of output timing may be set to 2 or less, or may be set to 4 or more. The criterion for determining the output timing may not be limited to the entrance 30, and may be appropriately set in the target road rest facility 3 and its surroundings. Further, the output timing index does not have to be limited to the distance. For example, the output timing may be calculated with other indicators such as time. The time length of the second interval may correspond to the running time of the approach road 31. The longer the time length of the second interval, the farther the entrance 30 is from the main area 33. The farther the entrance 30 is from the main area 33, the more difficult it may be to grasp the location of the charging facility 39 even if the guidance text 55 is output near the entrance 30. On the other hand, according to an example of the present embodiment, by setting the output timing of the guidance text 55 using the time length of the second interval as an index, it is possible to expect output control of the guidance text 55 at a timing suitable for grasping the location of the charging facility 39.

When all of the configurations of FIG. 3 are adopted, the target image data 50 may be configured to include the first image data 501, third image data 503, fourth image data 504 and the time information 520 of second image data 502. When the configuration of the first interval is omitted, the first image data 501 may be omitted from the target image data 50. When the configuration of the second interval is omitted, the time information 520 may be omitted from the target image data 50. When the configuration of the third interval is omitted, the third image data 503 may be omitted from the target image data 50. When the configuration of the fourth interval is omitted, the fourth image data 504 may be omitted from the target image data 50.

Further, the target image data 50 may or may not include image data in other interval other than each interval. For example, since the charging facility 39 is away from the branch point 32, an interval may occur between the end point of the third interval and the start point of the fourth interval. The target image data 50 may or may not include image data in this interval. At least a portion of the guidance text 55 may be generated from image data in other interval. In the example of FIG. 3, the third interval and the fourth interval are far from each other. However, the third interval and the fourth interval may not be limited to such examples. By arranging the charging facility 39 in a position close to the branch point 32, the third interval and the fourth interval may be continuous or may partially overlap each other. Each interval may be extracted in an arbitrary calculation process such as extraction of target image data 50 and image analysis.

### (Specific Example of Processing Procedure for Generating Guidance Text)

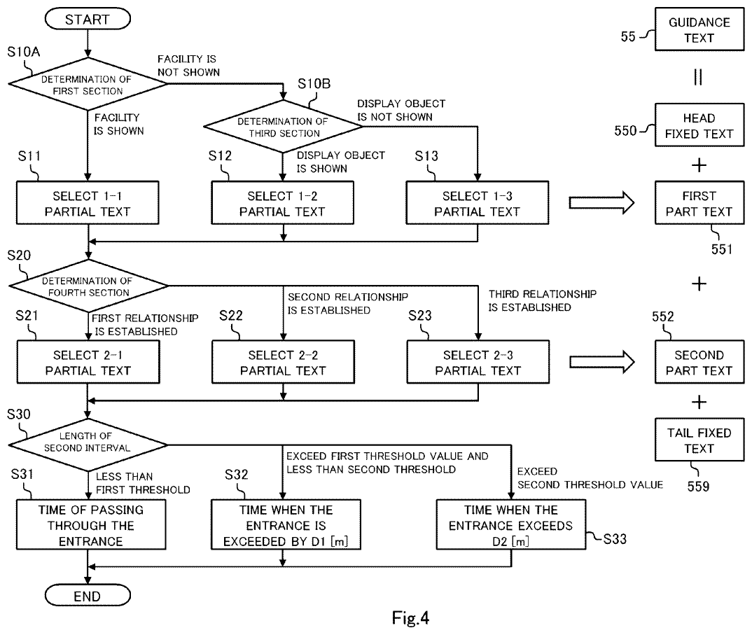

FIG. 4 indicate an example of a processing procedure for generating a guidance text 55 based on a rule. In an example of FIG. 4, it is assumed that a situation in which the guidance text 55 is generated on a rule-based basis after adopting all of the configuration of FIG. Before executing the process from step S10A, the server device 1 may acquire the target image data 50 from the in-vehicle device 2, including the first image data 501, the third image data 503, the fourth image data 504 and the time information 520 of the second image data 502. The server device 1 may perform image analysis on the acquired target image data 50.

In step S10A, the server device 1 may determine whether or not the predetermined facility 35 is detected from the result of image analysis on the first image data 501 as a determination of the first interval. The detection of the predetermined facility 35 corresponds to the fact that the predetermined facility 35 is shown in the first image data 501. When the predetermined facility 35 is detected, the server device 1 proceeds to step S11. On the other hand, if the predetermined facility 35 is not detected, the server device 1 proceeds to step S10B. In step S10B, the server device 1 may determine whether or not a predetermined display object has been detected from the result of image analysis on the third image data 503 as a determination of the third interval. The detection of a predetermined display object corresponds to the fact that the predetermined display object is shown in the third image data 503. When a predetermined display object is detected, the server device 1 proceeds to step S12. On the other hand, if a predetermined display object is not detected, the server device 1 proceeds to the process in step S13. In step S11, the server device 1 selects the 1-1 partial text 5511 as the first part text 551. In step S12, the server device 1 selects the 1-2 partial text 5512 as the first part text 551. In step S13, the server device 1 selects the 1-3 partial text 5513 as the first part text 551. When the first part text 551 used for the guidance text 55 is selected according to any of steps S11˜S13, the server device 1 proceeds with the process to the next step S20.

In step S20, the server device 1 determine the positional relationship between the predetermined facility 35 and the charging facility 39 from the result of image analysis against the fourth image data 504 as a determination of the fourth interval. When the charging facility 39 exists in front of the predetermined facility 35 (the first relationship is established), the server device 1 proceeds to step S21. When the charging facility 39 exists near the predetermined facility 35 (a second relationship is established), the server device 1 proceeds with the process in step S22. When the charging facility 39 exists beyond the predetermined facility 35 (a third relationship is established), the server device 1 proceeds with the process in step S23. In step S21, the server device 1 selects the 2-1 partial text 5521 as the second part text 552. In step S22, the server device 1 selects the 2-2 partial text 5522 as the second part text 552. In step S23, the server device 1 selects the 2-3 partial text 5523 as the second part text 552. When the second part text 552 used for the guidance text 55 is selected according to any of step S21˜S23, the server device 1 proceeds with the process to the next step S30.

In one example of the present embodiment, when the selection of the first part text 551 and the second part text 552 to be used is completed, the server device 1 can generate a guidance text 55. For example, the server device 1 can generate a guidance text 55 by connecting the head fixed text 550, the selected first part text 551, the selected second part text 552, and the tail fixed text 559. At least a portion of the first part text 551 and at least part of the second part text 552 may be provided by the template. Further, the head fixed text 550 and the tail fixed text 559 may also be provided by the template. The head fixed text 550 may consist of one or more words placed at the beginning of a text such as “charging facility is”. The server device 1 may appropriately acquire the head fixed text 550 and the tail fixed text 559. As a specific example, when the 1-1 partial text 5511 is selected as the first part text 551 and the 2-2 partial text 5522 is selected as the second part text 552, the server device 1 can generate the guidance text 55 “The charging facility proceeds toward the AAA facility and is near the AAA facility.” However, the contents of each text (550, 551, 552, 559) may not be limited to such examples, and may be appropriately changed according to the embodiment.

In step S30, the server device 1 determines the length of the second interval (the time length of the second image data 502) by referring to the time information 520.

When the length of the second interval is less than the first threshold, the server device 1 proceeds to step S31. If the length of the second interval exceeds the first threshold value and is less than the second threshold, the server device 1 proceeds to step S32. When the length of the second interval exceeds the second threshold value, the server device 1 proceeds with the process in step S33. In step S31, the server device 1 sets the output timing of the guidance text 55 to the time when the entrance 30 is passed. In step S32, the server device 1 sets the output timing of the guidance text 55 to the point in time when the vehicle has passed the entrance 30 by D1 [m]. In step S33, the server device 1 sets the output timing of the guidance text 55 to the point in time when the vehicle has passed the entrance 30 by D2 [m]. The setting information regarding the output timing may be appropriately stored together with the guidance text 55. When the output timing is set by any of steps S31˜S33, the server device 1 may end the process related to the generation of the guidance text 55.

Note that the processing procedure for generating the guidance text 55 may be appropriately changed according to the embodiment. For example, the order of processing in step S10A˜S13, process in step S20˜S23, and step S30˜S33 may not be limited to the example in FIG. 4. Each process may be executed at least partially in parallel. If the first part text 551 is not used, the processing of steps S10A˜steps S13 may be omitted. If the 1-3 partial text 5513 is not used, the processing of step S13 may be omitted. If the second part text 552 is not used, the processing of steps S20 ˜S23 may be omitted. If the output timing is not set, the processing of steps S30˜S33 may be omitted. The number of branches in at least one of step S20 and step S30 may be appropriately changed.

Further, when it is assumed that at least one of the road surface indications (321, 322) and the display plate 323 are present at the branch point 32, in the image analysis of the third image data 503, the server device 1 may detect only one of the road surface indications (321, 322) and the display plate 323 as a display object. Accordingly, in step S10B, the server device 1 may determine whether or not a display object of one of the road surface indications (321, 322) and the display plate 323 has been detected. When one display object is detected, in step S12, the server device 1 may select a text guiding the charging facility 39 in the direction of the charging facility 39 based on the detected display object as the first part text 551. If one display object is not detected, in step S13, the server device 1 may select a text guiding the charging facility 39 in the direction of the charging facility 39 based on the other display object as the first part text 551.

### (Saving the Guidance Text)

The generated guidance text 55 may be stored in an arbitrary storage area. In one example, the generated guidance text 55 may be stored in a storage area accessible by the terminal of the user who uses the target road rest facility 3 after the target vehicle VE. The user terminal may be, for example, an in-vehicle device, another user terminal, or the like. The arbitrary storage area may be, for example, a memory resource of the server device 1, an external computer (external server, etc.), a memory resource of a terminal, and the like. In another example, the generated guidance text 55 may be appropriately provided to the user's terminal after the user's terminal is stored in an inaccessible storage area.

Further, the generated guidance text 55 may be provided to the user in any way. In one example, there may be an external server that provides map information. The server device 1 may provide the generated guidance text 55 to the external server. The external server may provide the guidance text 55 together with the map information in response to a request from the user terminal. In another example, the server device 1 may also serve as a server device that provides map information by holding map information. In this case, the server device 1 may provide the guidance text 55 together with the map information to each user terminal.

### (Data Format of Guidance Text)

The data format of the generated guidance text 55 may be arbitrarily selected. In one example, the guidance text 55 may consist of only text data, text data and audio data, or only audio data. The audio data constituting the guidance text 55 may be appropriately generated. In one example, in the process of generating the guidance text 55, the server device 1 may directly generate audio data. In another example, the server device 1 may indirectly generate audio data by generating text data and then converting the generated text data into speech.

In the terminal of the user who uses the generated guidance text 55, the guidance text 55 may be reproduced as it is, or may be reproduced after any preprocessing has been applied. By employing the latter, the data format of the guidance text 55 may be different when it is generated by the server device 1 and when it is reproduced by the terminal.

For example, the server device 1 may generate a guidance text 55 with text data. The terminal may convert the generated text data into speech as a preprocessing. The terminal may reproduce the audio data obtained by the audio conversion as the guidance text 55.

### 2 Configuration Example

### (Server Device)

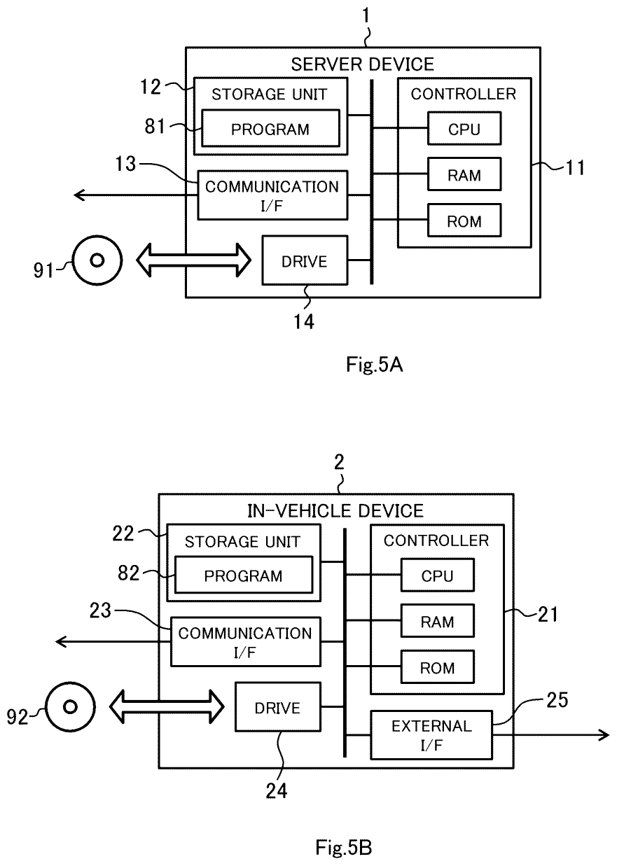

FIG. 5A schematically indicates an example of the hardware configuration of the server device 1 according to the present embodiment. The server device 1 according to the present embodiment is a computer to which the controller 11, the storage unit 12, the communication interface 13, and the drive 14 are electrically connected.

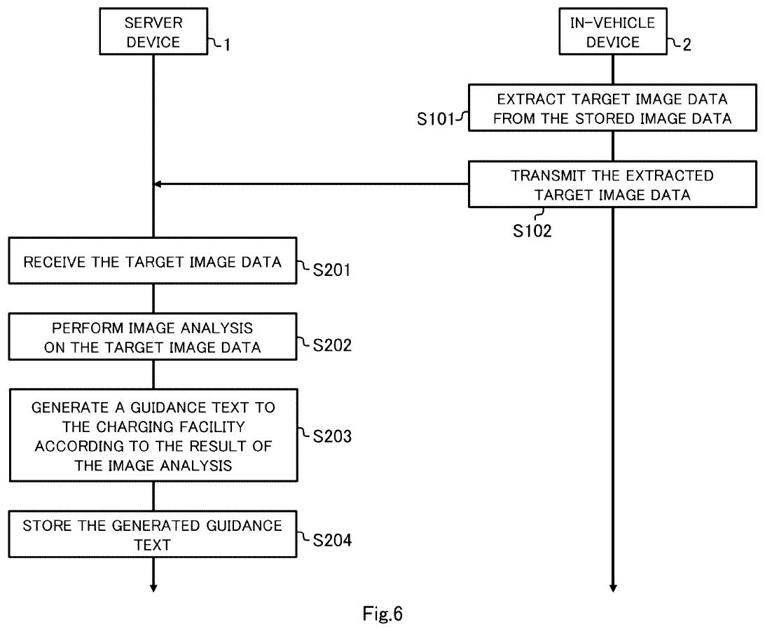

The controller 11 includes a CPU (Central Processing Unit), RAM (Random Access Memory), ROM (Read Only Memory), and the like, and is configured to execute arbitrary information processing based on a program and various data. The controller 11 (CPU) is an example of a processor resource. The storage unit 12 may be configured by, for example, any storage device such as a hard disk drive, a solid-state drive, or a semiconductor memory. storage unit 12 (and RAM, ROM) is an example of a memory resource. In the present embodiment, the storage unit 12 stores various information such as the program 81. The program 81 is a program for causing the server device 1 to execute information processing (FIG. 6 described later) for the generation of the guidance text 55. Program 81 includes a series of instructions for the processing of the information.

The communication interface 13 is configured to perform wired or wireless data communication via a network. The communication interface 13 may be configured by, for example, a wired LAN (Local Area Network) module, a wireless LAN module, or the like. In the present embodiment, the server device 1 may perform data communication via a network with another computer (for example, the in-vehicle device 2) using the communication interface 13.

The drive 14 is a device for reading various information such as programs stored on the storage medium 91. The program 81 may be stored on the storage medium 91 instead of or with the storage unit 12. The storage medium 91 is configured to store the information by electrical, magnetic, optical, mechanical or chemical action so that a machine such as a computer can read various information (programs, etc.). The storage medium 91 is an example of a non-transitory storage medium. The storage medium 91 may be a disk-type storage medium such as a CD or DVD, or a storage medium other than a disk-type such as a semiconductor memory (for example, flash memory). The type of drive 14 may be appropriately selected according to the type of storage medium 91.

With regard to the specific hardware configuration of the server device 1, the component can be omitted, replaced, and added as appropriate according to the embodiment. For example, the controller 11 may include a plurality of hardware processors. The hardware processor may be composed of a microprocessor, a field-programmable gate array (FPGA), a digital signal processor (DSP), an electronic control unit (ECU), a graphics processing unit (GPU), an application specific integrated circuit (ASIC), etc. Drive 14 may be omitted. The program 81 may be stored in an external storage device such as, for example, a NAS. An external storage device is also an example of a non-transitory storage medium. The server device 1 may additionally include an input device and an output device. The server device 1 may be a general-purpose server device, a general-purpose PC (Personal Computer), or the like in addition to a computer designed specifically for the purpose.

### In-Vehicle Device

FIG. 5B schematically indicates an example of the hardware configuration of the in-vehicle device 2 according to the present embodiment. The in-vehicle device 2 according to the present embodiment is a computer to which the controller 21, the storage unit 22, the communication module 23, the drive 24, and the external interface 25 are electrically connected. The controller 21˜drive 24 and the storage medium 92 of the in-vehicle device 2 may be configured in the same manner as the controller 11˜drive 14 and the storage medium 91 of the server device 1, respectively.

The controller 21 (CPU) is an example of the processor resource of the in-vehicle device 2. The storage unit 22 (and RAM, ROM) is an example of the memory resource of the in-vehicle device 2. In the present embodiment, the storage unit 22 stores various information such as the program 82. The program 82 is a program for causing the in-vehicle device 2 to execute information processing (FIG. 6 described later) for generating the guidance text 55. Program 82 includes a series of instructions for the information processing. The program 82 may be stored on the storage medium 92 instead of or with the storage unit 22. The external interface 25 is configured to connect to an external device via a wired or wireless connection. The external interface 25 may be configured by, for example, a USB (Universal Serial Bus) port, a dedicated port, a communication port, or the like. When the external interface 25 includes a communication port, the communication standard of the communication port may be arbitrarily selected. In the present embodiment, the in-vehicle device 2 may be connected to the driving recorder DR via the external interface 25.

With regard to the specific hardware configuration of the in-vehicle device 2, the component can be omitted, replaced, and added as appropriate according to the embodiment. For example, the controller 21 may include a plurality of hardware processors. Drive 24 may be omitted.

The program 82 may be stored in an external storage device.

The in-vehicle device 2 may additionally include an input device and an output device. The in-vehicle device 2 may be a mobile terminal (including a smartphone), a tablet terminal, a notebook PC, or other general-purpose PCs, in addition to a computer designed specifically for use.

### 3 Operation Example

FIG. 6 is a sequence diagram indicating an example of a processing procedure related to the generation of a guidance text 55 by the system 100 according to the present embodiment. The controller 11 of the server device 1 executes instructions included in the program 81 by the CPU. The controller 21 of the in-vehicle device 2 also executes instructions included in the program 82 by the CPU. As a result, server device 1 and in-vehicle device 2 are respectively in FIG. 6 below. Acts as a computer capable of executing information processing. The following processing procedure of at least one of the server device 1 and the in-vehicle device 2 is an example of an information generation method (information processing method) executed by a computer. However, the following processing procedure is only an example, and each step may be modified as much as possible. Further, the following processing steps can be omitted, replaced, and added as appropriate according to the embodiment.

In step S101, the controller 21 extracts target image data 50 from the image data 40 stored by the driving recorder DR when the target vehicle VE is charged at the charging facility 39 at the target road rest facility 3. In step S102, the controller 21 transmits the extracted target image data 50 to the server device 1. In one example, the in-vehicle device 2 may autonomously execute the processes of steps S101 and S102 in response to using the charging facility 39 at the target road rest facility 3. In another example, the in-vehicle device 2 may determine whether or not the charging facility 39 has been used in response to a request from the server device 1. When it is determined that the charging facility 39 is used, the in-vehicle device 2 may execute the processes of steps S101 and S102.

In step S201, the controller 11 receives the target image data 50 from the in-vehicle device 2. In step S202, the controller 11 performs image analysis on the target image data 50. In step S203, the controller 11 generates a guidance text 55 to the charging facility 39 according to the result of the image analysis. In one example, the controller 11 may generate a guidance text 55 by the method of FIG. 3. When the rule-based is adopted, the controller 11 may generate a guidance text 55 in the processing procedure of FIG. 4. In one example, the controller 11 may set the output timing of the generated guidance text 55. In addition, in one example, when an end-to-end model is used as the machine learning model, the controller 11 may simultaneously perform the processes of steps S202 and S203 by providing the target image data 50 to the trained machine learning model and executing calculation processing of the trained machine learning model.

In step S204, the controller 11 stores the generated guidance text 55. The storage destination may be appropriately selected according to the embodiment. The storage destination may be selected from, for example, a RAM, a storage unit 12, a storage device of an external computer, a storage device of a terminal using the guidance text 55, or the like. In one example, the controller 11 may distribute the guidance text 55 to the user terminal existing in the vicinity of the target road rest facility 3 as a storage process or separately from the storage process. The controller 11 may directly distribute the guidance text 55 to the terminal, or may indirectly distribute it to the terminal via an external server or the like. By distributing the generated guidance text 55, the controller 11 may give a command to output the guidance text 55 to the user terminal located in the vicinity of the target road rest facility 3.

The controller 11 may distribute the guidance text 55 including the output timing setting, thereby giving the terminal a command to output the guidance text 55 at the set output timing. The terminal may include a positioning module and an output device. The terminal may measure the current position by the positioning module, and output the guidance text 55 to the output device when the measured current position satisfies the output timing setting. When the generated guidance text 55 is saved, the system 100 terminates the processing procedure according to the present operation example.

### [Features]

In the present embodiment, by processing steps S202˜S203, at least a part of the guidance information to the charging facility 39 (guidance text 55) can be automatically generated by utilizing the target image data 50 captured by the driving recorder DR of the target vehicle VE that visited the target road rest facility 3. Thereby, it can be expected to reduce the cost of generating guidance information.

### 4 Modifications

As described above, embodiments of the present disclosure have been described in detail, but the description up to the above is only an example of the present disclosure in all respects. The processes and means described in the present disclosure can be freely combined and implemented insofar as no technical contradictions arise. In the above embodiment, various improvements or modifications may be appropriately performed.

For example, in the above embodiment, the server device 1 is an example of an information processing apparatus. However, the form of the information processing apparatus may not be limited to such examples. In another example, another computer, such as the in-vehicle device 2, may operate as an example of information processing. In the above embodiment, at least a part of the information processing of the server device 1 may be executed by the in-vehicle device 2. At least a part of the information processing of the in-vehicle device 2 may be executed by the server device 1. One of the server device 1 and the in-vehicle device 2 may perform a series of information processing from extracting the target image data 50 to storing the guidance text 55. In this case, extracting the target image data 50 is an example of acquiring the target image data 50. When the generation of the guidance text 55 is executed by the in-vehicle device 2, the in-vehicle device 2 may store the generated guidance text 55 in an arbitrary storage area. For example, the in-vehicle device 2 may transmit the guidance text 55 generated to an external server that stores information used for guidance such as map information.

What is claimed is:

1. A system comprises:
a server device; and
an in-vehicle device deployed in a target vehicle,
wherein the in-vehicle device is configured to execute:
when the target vehicle is charged at a charging facility at a target road rest facility, extracting a target image data from an image data stored in a driving recorder of the target vehicle, the target image data captured during an interval from when the target vehicle starts entering the target road rest facility to when the target vehicle arrives at the charging facility, and
transmitting the extracted target image data to the server device, and
wherein the server device is configured to execute:
receiving the target image data from the in-vehicle device,
performing image analysis on the received target image data,
generating a guidance text to the charging facility at the target road rest facility according to a result of the image analysis, and
storing the generated guidance text for providing to a user who uses the target road rest facility.

2. A information generation method to be executed by a computer, the information generation method comprising:
acquiring target image data from a driving recorder of a target vehicle using a charging facility at a target road rest facility, the target image data captured during an interval from when the target vehicle starts entering the target road rest facility to when the target vehicle arrives at the charging facility,
performing image analysis on the acquired target image data,
generating a guidance text to the charging facility at the target road rest facility according to a result of the image analysis, and
storing the generated guidance text for providing to a user who uses the target road rest facility.

3. The information generation method according to claim 2, wherein
the acquired target image data includes a first image data captured in a first interval from before an entrance of the target road rest facility to passing through the entrance, and
when a predetermined facility is shown in the first image data, the generated guidance text includes a text that guides a direction of the charging facility based on the predetermined facility.

4. The information generation method according to claim 3, wherein
the acquired target image data further includes a third image data captured in a third interval including a branch point in the target road rest facility, and
when the predetermined facility is not shown in the first image data and a predetermined display object is shown in the third image data, the generated guidance text includes a text that guides the direction of the charging facility based on the predetermined display object.

5. The information generation method according to claim 2, wherein
the acquired target image data includes time information indicating a time length of a second image data captured in a second interval after passing through the entrance of the target road rest facility and before passing through the branch point, and
generating the guidance text includes setting an output timing of the guidance text when providing the guidance text to the user according to the time length indicated by the time information.
